(19) United States
(12) Patent Application Publication
(10) Pub. No.: US 2006/0224585 A1
(43) Pub. Date: Oct. 5, 2006

(54) Method and system for managing and searching a supplier database structure

(76) Inventor: Herbert E. Brockmeier, Rose Hill, KS (US)

Correspondence Address: MANUFACTURING EDUCATION & SYSTEMS, INC., 914 RIDGEWAY ROAD, ROSE HILL, KS, 67133, US

(21) Appl. No.: 11/389,589

(22) Filed: Mar. 27, 2006

Related U.S. Application Data
(60) Provisional application No. 60/665,998, filed on Mar. 29, 2005.

(51) Int. Cl. G06F 17/30

(52) U.S. Cl. 707/6

(57) ABSTRACT

What is disclosed is a method, software product and database structure for storing, searching and managing multi-dimensional, discrete supplier capabilities and characteristics. This method and system consists creating, searching and maintaining a database structure containing discrete definitions of supplier material specialties, industries they serve, product families they produce, detailed processes and services they perform and certifications that they have achieved. It also consists of a search process that allows system users to perform a complex search of the supplier database structure using a multi-dimensional search string containing a combination of required supplier capabilities and characteristics. The software search process returns a list of suppliers who possess the requested capability and characteristic profile and allows system users to display a detailed supplier profile. It also provides system functionality which allows users to select any or all matching suppliers and start an email server client to send documents, specifications and tables.

This application is based on and claims benefit from, provisional U.S. patent application No. 60/665,998 entitled “Supplier Capability Tool” filed on Mar. 29, 2005.

### BRIEF SUMMARY OF THE INVETION

This disclosure is a unique method, software and database structure for storing, searching and managing supplier capabilities and characteristics. This method and system consists of a database structure containing discrete definitions of supplier material specialties, industries they serve, product families they produce, detailed processes and services they perform and certifications that they have achieved. It contains a process and software to create, store, search and maintain the supplier capability database structure. It also consists of a search process that allows system users to perform a complex search of the supplier database structure using search parameters based on a multiplicity of supplier capabilities and characteristics. The software search process returns to the system user, a list of suppliers who possess the requested capabilities and characteristics and provides for functionality so that system users can display a detailed supplier profile. It also provides system functionality which allows users to select any or all displayed suppliers and start an email client software to send documents, specifications and tables.

### FIELD OF THE INVENTION

This invention especially relates to supplier selection and product sourcing and more particularly, the invention relates to supplier management processes and specifically the process to identify, capture, manage and use information related to the discrete business and process capabilities of companies which supply goods and services (suppliers).

### BACKGROUND OF THE INVENTION

Supplier management processes are rapidly changing to adapt to ever increasing demands for faster acquisition of materials and services in a global economy. Another driving force is the demand for products and services at lower costs and higher quality.

In trying to achieve these goals, companies are constantly developing new products or modifying existing products. To achieve these changes, companies must understand the various capabilities required to produce new products and locate suppliers who possess the required capabilities. Researching and maintaining supplier capabilities on a global basis is costly and time consuming. While some processes exist that permit informational searches of database structures via computer, existing methods typically limit searches to a single supplier characteristic or capability per search. Existing search systems and supplier directories do not contemplate the need of sourcing specialists for complex search capabilities based on a multiplicity of diverse supplier characteristics or capabilities.

This invention is a unique method, software and database structure to effectively capture, manage, control, display and maintain the capabilities and characteristics of companies that provide products, materials and services.

The method, software and database structure provide the ability to capture, store, search, display and manipulate the following information relating to a supplier: contact information, country or state of location, industries that the supplier provides services to, materials that the supplier specializes in, product families that the supplier produces, detailed processes and services that the supplier performs, and certifications that the supplier has achieved. It contains processes and logic to keep supplier capability information in a pending status awaiting approval by a system administrator.

It provides the software functionality to simultaneously search on a multiplicity of diverse supplier characteristics and capabilities thus rapidly locating and displaying all suppliers with a required capability and characteristic profile.

It provides the capability of reviewing detailed supplier information. It also provides the capability to start an email client to quickly contact single or multiple suppliers.

The Manner and Process of Making and Using

The method, software and database structure can be made by identifying an organization to accept, plan and implement the business process and responsibility and to develop the computing processes and database structure to store, maintain, search, and display supplier information.

Computing software products must be designed and developed to capture, store, search, display, manipulate and communicate supplier capability information. A database structure containing the supplier capability and characteristic information must be designed and created which includes the following: industries that the supplier serves; materials that the supplier specializes in; product families that the supplier produces, distributes, sells or manages; processes or services that the supplier performs; certifications that the supplier has achieved. Software products must be created for a system administration process to review, approve and manage the supplier capability information

Software programs must be created to simultaneously search on any or all of the categories of supplier capability information. This would include simultaneously searching on a combination of any or all the following information: country or state of location; industries that the supplier provides services for; materials that the supplier specializes in; product families that the supplier produces; detailed processes and services that the supplier performs (this includes simultaneously searching on a single process or multiple processes); certifications that the supplier has achieved (this includes simultaneously searching on a single certification or multiple certifications).

Create a process to display a list of suppliers that match the search profile the search results. Also create a process to display detailed supplier information. Create a process to start an email client to contact the supplier or companies identified from the search via email. The method and responsibilities must be communicated to employees and suppliers. Training materials should be developed. Use of the system and process should be communicated.

### BRIEF DESCRIPTION OF DRAWINGS

FIG. 1: Is a general flow diagram of the major processes.

FIG. 2: is a diagram of the processes to store and maintain information in the supplier capability database structure.

FIG. 3: is a supplier capability and characteristic data relationship diagram.

FIG. 4: is a diagram of the method to create a search string of required supplier capabilities and characteristics, search the supplier capability database structure, and return results to the system user.

FIG. 5: Method to maintain supplier capability and characteristics and process authorization and system administration.

### DETAILED DESCRIPTION

Methods and system are disclosed for capturing, storing, searching and managing multi-dimensional, discrete supplier capabilities and characteristics. This invention consists of a database structure, search logic and supplier information management processes and system. The supplier capability database structure contains discrete definitions of supplier material specialties, industries they serve, product families they produce, detailed processes and services they perform and certifications that they have achieved.

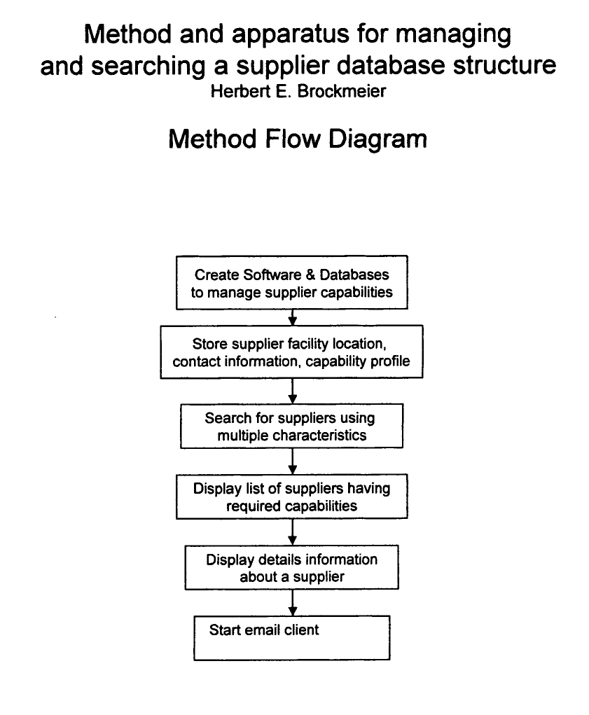

FIG. 1 illustrates one embodiment of a system to capture, store, manage, search and display the capabilities and characteristics of a supplier from a supplier database structure. The database structure contains location and contact information for the supplier. Key to this invention is the capturing and storing of supplier characteristic and capability data more specifically supplier material specialties, industries they serve, product families they produce, detailed processes and services they perform and certifications that they have achieved.

Suppliers may choose to specialize in specific materials and not in others. Their manufacturing processes and technical expertise may be focused on a particular material or materials. Storing a list of material specialties of a supplier allows the system user to search on and communicate with suppliers of a particular material.

Suppliers may also focus their manufacturing products, processes and services towards a particular industry, for example, aerospace, agricultural or medical. Storing a list of industry specialties of a supplier allows the system user to search on and communicate with suppliers to a specific industry.

In addition, suppliers generally produce products that can be grouped into a product family or families such as machined parts, electrical assemblies or children's clothing.

This invention provides for the storing, searching and management of product families that a supplier produces. Storing a list of product families that a supplier provides allows the system user to search on and communicate with suppliers of a particular product family.

Most suppliers perform more than one type of detailed manufacturing process within their facility. For example: molding, cutting, pressing, painting, assembly and milling. This method and system provides for the storing of all detailed processes and services performed by a supplier. It also provides the capability to simultaneously search for a supplier who provides a zero, one or many processes.

Many suppliers have achieved certification or accreditation from various organizations. This method and system allows for the capturing and storing of certifications that the company has achieved or holds. It also provides the capability to simultaneously search for a supplier who holds zero, one or many certifications e.g., ISO9001 certified and FAA certified.

By storing supplier capabilities and characteristics in a database structure, system users can quickly identify all suppliers who possess a required profile containing a complex multiplicity of capabilities and characteristics eliminating multiple data searches and queries. This method and system provides a method to build a required capability and characteristic profile search string to be compared to the capabilities and characteristics of a supplier contained in the database structure. The software search process returns a list of suppliers who possess the requested capability and characteristic profile and allows system users to display detailed information about the supplier. Based on the information returned from the search of the supplier database structure, a system user can communicate with a supplier via electronic mail (email). This method and system provides for the functionality to start email client software and pass to it a list of email address of supplier that the system user has selected to contact.

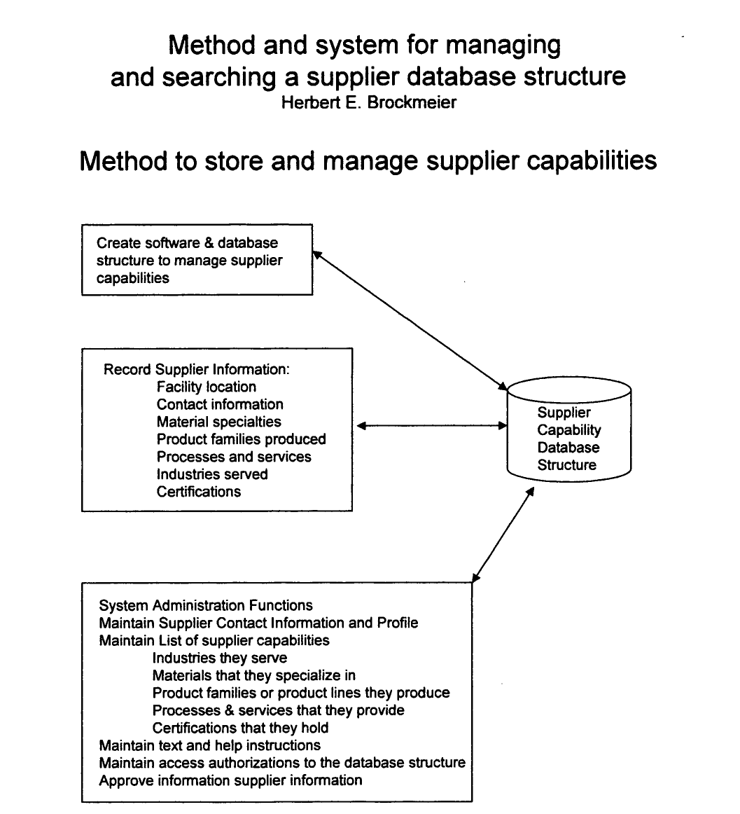

FIG. 2. Illustrates the embodiment of a process and software product to store and manage supplier profile information. In this illustration a database structure is designed and developed to store a multi-dimension supplier capability and characteristic profile. A typical supplier database structure contains general information relating to the supplier consisting of supplier facility and contact information. This invention expands on that functionality and contains a database structure of information discretely storing, searching and maintaining supplier material specialties, industries that they serve, families of products that they produce, processes and services they perform and certifications that they hold.

In addition this invention includes a system administration method and software to approve supplier profile information. Functionality is provided allowing the system user to review and approve supplier capability and characteristic information prior to the information being made available to the search and display process. Functionality is provided so that information can be withheld from the search process by identifying the information as being non-approved. A process and system is provided to approve supplier profile information following a review process. A system access authorization process is provided to control access to and use of the system.

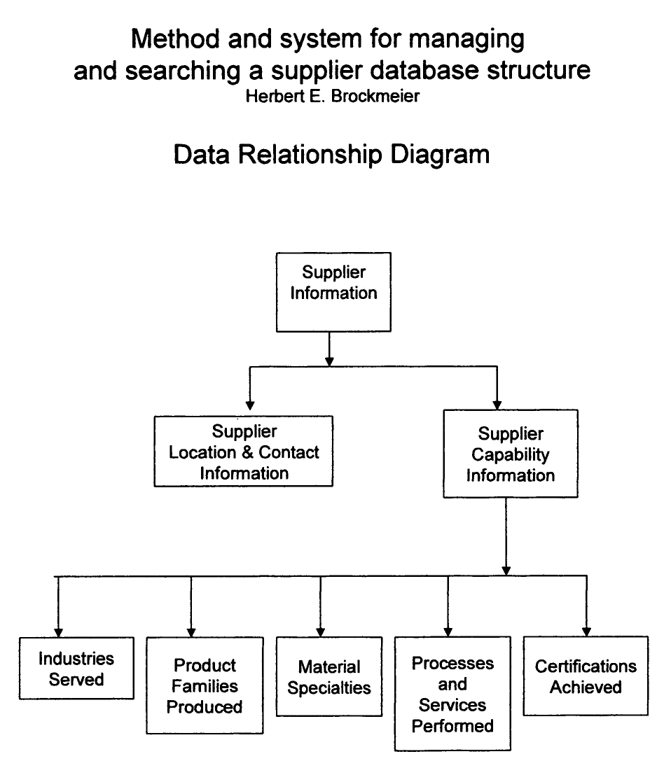

FIG. 3 illustrates the relationship of supplier capability information to other supplier information. In many cases, supplier location and contact information is contained in another database structure. This invention provides for additional, discrete information concerning supplier capabilities and characteristics. FIG. 3 illustrates the relationship of existing supplier information to the discrete capability and characteristic information of this invention. New database structures are identified that contain industries served, material specialty, process and service, product families and certifications information pertaining to a supplier. These data structures are discrete lists of information which comprise the supplier capability and characteristic profile. These data structures can contain zero, one or many entries for each supplier.

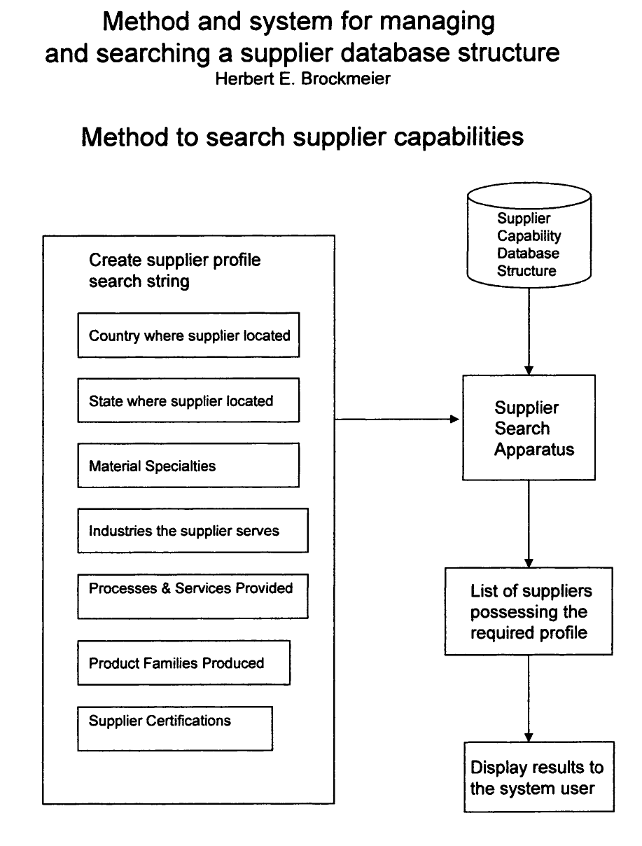

FIG. 4 depicts the method software process whereby the system user creates a supplier characteristic and capability search string and submits it to the supplier search software process. The system user can identify a complex multiplicity of required supplier characteristics to be submitted to the search process. The system user can include in the search string: company location (e.g. country or state) material specialty, industry served, processes and services provided (zero, one or many), product family produced and certifications held (zero, one or many). This complex list of required supplier capabilities and characteristics comprises the supplier capability search string.

The supplier search software receives the supplier capability search string and compares the contents of the search string to the supplier profiles contained in the supplier capability database structure. A list of all suppliers possessing all of the required capabilities and characteristics contained in the search string is displayed to the system user. At the system user discretion, the search process can include or ignore supplier information that has not been approved. Functionality is provided allowing a system user to select a supplier to view additional detailed information. Notification is given to the system user if the results of the search indicate that there are no suppliers possessing all of the capabilities and characteristics contained in the search string.

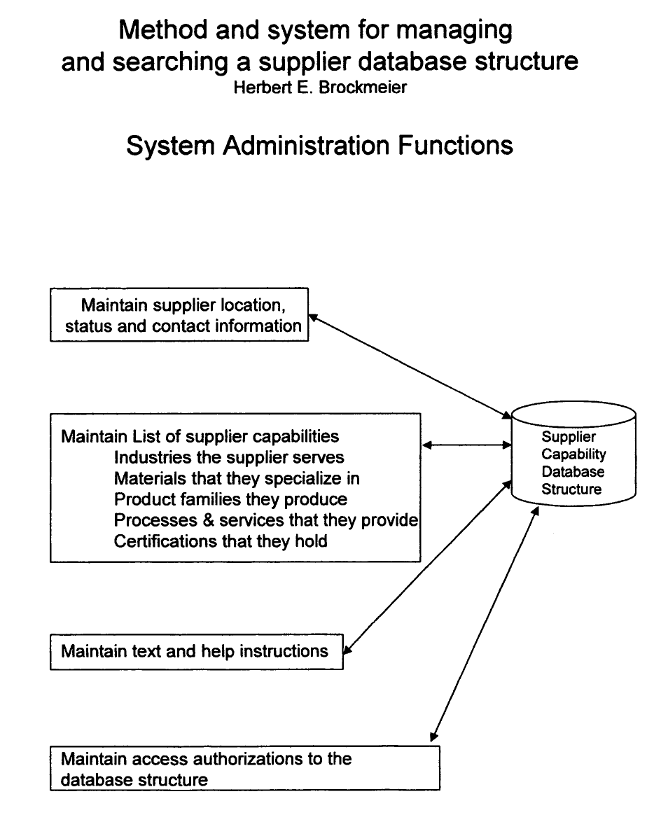

FIG. 5 illustrates the administration functions required of the method and process. Supplier contact, location and status information is maintained. This information consists of details such as location, website address, sales contact, quality assurance contact, annual sales and number of employees. Functionality is provided to maintain the details of the supplier capability and characteristic profile. The system user can change the material specialties, processes and services, industries served, product families produced and certifications held. The system user can edit changes to the supplier profile and hold information in a non-approved status until later approved. Functionality is also provided to control access to the supplier capability database structure and to maintain text and help instructions.

It will be appreciated by those of ordinary skill in the art that the present invention can be embodied in other specific forms without departing from the spirit or essential characteristics thereof. The presently disclosed embodiments are therefore considered in all respects to be illustrative, and not restrictive. The scope of the invention is indicated by the appended claims, rather than the foregoing description, and all changes that come within the meaning and range of equivalents thereof are intended to be embraced therein.

What is claimed is:

1. A unique method, software product and database structure to manage and provide visibility of complex, multi-dimensional supplier characteristics and capabilities, the method comprising:
(a) A method, software product and database structure to create, store and maintain supplier information relating to the specific processes and services suppliers perform, materials that they specialize in, certifications that they hold, industries that they specialize in, and product families they produce; and
(b) A method and software product to create a supplier profile search string for a multiplicity of supplier characteristics and capabilities which can include a combination of specific processes and services they perform, material specialties, certifications, industry specialties, country or state location, product families produced; and
(c) A method and software product which uses a supplier profile search string to search a supplier capability database structure and return to the system user a list of all suppliers in the database structure who possess the required capability and characteristic profile; and
(d) A method and software product to display to the system user a list of suppliers meeting the required capability profile and display detail capacity and characteristic information about the supplier; and
(e) A method and software product to initiate the system user email client passing to it a list of supplier contact email addresses.

2. A method, software product and database structure according to claim 1, wherein step (a) further comprises storing and maintaining supplier characteristics and capabilities information, the method comprising:
2(a) A method, software product and database structure for storing and maintaining a table of industries to which the supplier provides products and services; and
2(b) A method, software product and database structure for storing and maintaining a table of materials that the supplier specializes in processing, servicing or distributing; and
2(c) A method, software product and database structure for storing and maintaining a table of product families that the supplier produces or distributes; and
2(d) A method, software product and database structure for storing and maintaining a table of processes and services that the supplier performs; and
2(e) A method, software product and database structure for storing and maintaining a table of certifications that the supplier has achieved or holds; and
2(f) a method and software product to permit that only authorized system users can view or maintain supplier capability and characteristic information; and
2(g) a method and software product for reviewing, creating and modifying the supplier capability and characteristic database structure by an authorized system user; and
2(h) a method and software product for identifying supplier capability and characteristic information as unapproved by an authorized system user; and
2(i) a method and software product to allow or not allow a search of unapproved supplier capability or characteristic information.

3. A method and software product according to claim 1, wherein step (b) further comprises creating a supplier profile search string of any or all supplier capabilities and characteristics, the method comprising:
3(a) a method and software product which allows the system user to discretely identify the country where the required supplier must be located; and
3(b) a method and software product which allows the system user to discretely identify the state where the required supplier must be located; and
3(c) a method and software product which allows the system user to discretely identify an industry to which the supplier provides goods and services; and
3(d) a method and software product which allows the system user to discretely identify a product family that the supplier produces or distributes; and
3(e) a method and software product which allows the system user to discretely identify a material in which the supplier specializes or distributes; and
3(f) a method and software product which allows the system user to discretely identify zero, one or many processes and services the supplier performs; and
3(g) a method and software product which allows the system user to discretely identify zero, one or many certifications that the supplier holds or has achieved; and
3(h) a software product to combine all identified characteristics into a supplier profile search string; and
3(i) a method and software product to submit the supplier profile search string to a database structure search process.

4. A method and software product according to claim 1, wherein step (c) further comprises:
4(a) a method and software product to initiate the search of the supplier capability database structure; and
4(b) a software product to search the capabilities and characteristics of each supplier in the supplier capability database structure using the supplier profile search string; and
4(c) a software product to compare information from the supplier profile search string to the supplier capabilities and characteristics in the supplier database structure; and
4(d) a software product to identify all suppliers which possess all of the characteristics and capabilities in the supplier profile search string; and
4(e) a software product to create and display to the system user a list of all suppliers who possess all of the capabilities and characteristics in the supplier profile search string; and
4(h) a software product wherein suppliers that do not possess the characteristics and capabilities contained in the supplier profile search criteria are omitted from the search output result; and
4(i) a software product which controls whether supplier information that is unapproved is to be displayed to the system user.

5. A method according to claim 1, wherein step (d) further comprises:
5(b) a software product to display to the system user, summary overview information about each supplier possessing the required characteristics and capabilities that match the supplier profile search string created in claim 2; and
4(g) a software product to notify the system user if there are no suppliers in the supplier database structure that match all of the capabilities and characteristics in the supplier profile search string; and
5(c) a software product to display detail information for a supplier possessing the characteristics and capabilities that match the supplier profile search string created in claim 2 including all industries served, all product families produced, all material specialties, all detailed processes and services performed and all company certifications; and
5(d) a method and software product which allows the system user to select suppliers that they wish to contact via email; and

6. A method and software product according to claim 1, wherein step (e) further comprises contacting suppliers, the method comprising:
6(a) A method and software product which provides the system user the ability to identify each supplier that the system user wishes to contact; and
6(b) A method and software product which provides the ability to display supplier contact information for all of the suppliers selected to contact; and
6(c) a method and software product which provides the ability to start the system user email client.
